(19) United States
(12) Patent Application Publication
(10) Pub. No.: US 2017/0203617 A1
(43) Pub. Date: Jul. 20, 2017

(54) TYRE COMPRISING A FOAM MATERIAL FOR SOUND ABSORPTION

(71) Applicants: Pasquale AGORETTI, Ariccia (IT); Alessandra BARTOLONI, Roma (IT); Michele AMURRI, Roma (IT); John HOUSE, Roma (IT)

(72) Inventors: Pasquale AGORETTI, Ariccia (IT); Alessandra BARTOLONI, Roma (IT); Michele AMURRI, Roma (IT); John HOUSE, Roma (IT)

(73) Assignee: BRIDGESTONE CORPORATION, Tokyo (JP)

(21) Appl. No.: 15/326,708

(22) PCT Filed: Jul. 21, 2015
(86) PCT No.: PCT/IB2015/055524

§ 371 Date: Jan. 17, 2017

(30) Foreign Application Priority Data
Jul. 21, 2014 (IT) RM2014A000405

(51) Int. Cl. B60C 19/00; B60C 5/00

(52) U.S. Cl. CPC B60C 19/002; B60C 5/002

(57) ABSTRACT

A tyre comprising an impermeable layer suitable to ensure the sealing under pressure of the air contained in the inner cavity of the carcass and a foam material with auxetic characteristics, which is housed inside the cavity and suitable to provide sound absorption.

### TECHNICAL FIELD

The present invention relates to a tyre comprising a foam material for sound absorption. More precisely, the present invention relates to a tyre comprising a foam material with auxetic characteristics housed in the inner cavity that, in service, is filled with air under pressure.

### BACKGROUND ART

One of the noises produced by a tyre in service regards the resonance cavity sound generated by vibration of the air under pressure inside its inner cavity. To reduce this type of noise, the use of a porous material applied to the air-impermeable layer of the tyre's inner cavity in a manner such that the resonance cavity sound is absorbed by the porous material has long been known. The porous material most commonly used for this purpose is polyurethane.

Despite being able to achieve the required sound absorption, the foam materials used up until now still suffer from a decrease in their sound absorption capacity during operation of the tyre and in particular with the increase in its speed of rotation. In fact, during operation of the tyre, the foam material housed in the inner cavity is subjected to a compression action that, necessarily, entails a decrease in its porosity. As will be immediately evident to a person skilled in the field, this effect necessarily results in a drop in the sound absorption capability of the material. Obviously, the greater the running speed of the tyre, the greater will be its drop in terms of sound absorption.

In other words, the faster the vehicle travels, the less will be the sound damping effect of the porous materials inserted in the tyres and, in consequence, the greater will be the resonance noise coming from them.

The need was thus felt to have a foam material the technical specifications of which are such as to avoid its performance dropping in terms of sound absorption as the speed of rotation of the tyre increases.

### DISCLOSURE OF INVENTION

The subject of the present invention is a tyre comprising an impermeable layer suitable to ensure the sealing under pressure of the air contained in the inner cavity of the carcass and a foam material housed inside said cavity and suitable to provide sound absorption; said tyre being characterized in that said foam material is an auxetic material.

Preferably, said foam material has a Poisson's ratio of less than zero.

Preferably, said foam material has a density ranging from 0.01 g/cm³ to 0.15 g/cm³.

Preferably, said foam material is housed on the surface of the impermeable layer of the inner cavity of the tyre.

Preferably, said foam material occupies a volume ranging from 0.1% to 100% of the volume of the inner cavity. More preferably, said foam material has a thickness ranging from 10 mm to 200 mm and a width ranging from 10% to 100% of the width of the inner cavity.

Preferably, said foam material occupies a volume ranging from 0.4% to 20% of the volume of the inner cavity. More preferably, said foam material has a thickness ranging from 20 to 30 mm and a width ranging from 20% to 40% of the width of the inner cavity.

Preferably, said foam material is housed in the cavity in the form of a toroid, or in the form of a strip with a length equal to that of the impermeable layer, or in the form of single segments assembled so as to cover the entire length of the impermeable layer.

### BEST MODE FOR CARRYING OUT THE INVENTION

An embodiment is described below by way of non-limitative example.

The applicant has performed a comparison in terms of sound absorption between a polyurethane-based foam material normally used in tyres and the same material after being subjected to a mechanical/thermal treatment necessary to give it auxetic characteristics.

The sound absorption tests were performed on the two materials both in their ‘rest’ state and in their compression state, compression being applied to simulate the response of the porous material of the tyre in service.

The polyurethane-based foam material used has an apparent density of 0.025 g/cm³, a compression strength of 1.1 kPa and a tensile strength of 100 kPa with 500% elongation at break.

The procedure used for making the polyurethane foam material auxetic according to one of the methods described in the literature is described below, solely by way of example.

A sample of foam material with dimensions of 135 mm×135 mm×27 mm was compressed in a mould with dimensions of 100 mm×100 mm×20 mm (approximately 25% compression along each axis) and heated to a temperature of 200° C. for 10 minutes. After this period of heating, the sample was removed from the mould, stretched and reinserted in the mould where it was cooled to ambient temperature. At this point, the sample was heated again to 100° C. for one hour.

The sound absorption tests were performed according to the ISO 10534-2 Standard at a frequency ranging from 200 to 2000 Hz.

As anticipated above, comparative sound absorption tests were performed. In particular, four sound absorption tests were performed: (i) on untreated foam material (material A), (ii) on untreated foam material subjected to compression comparable to that of operation (material Ac), (iii) on treated foam material (material B), and (iv) on treated foam material subjected to compression comparable to that of operation (material Bc).

The values obtained were indexed to the value obtained for material A and are listed in Table I.

TABLE I

| | |
|---|---|
| Material A | 100 |
| Material Ac | 90 |
| Material B | 100 |
| Material Bc | 110 |

From the results obtained for the non-auxetic foam material (A and Ac), it can be concluded that the sound absorption capabilities of this material decrease when subjected to compression. Inversely, from the results obtained for foam material with auxetic characteristics, it can be concluded that when the foam material is subjected to compression, its sound absorption capabilities not only do not drop, but increase. Therefore, the evidence of the experimental tests performed unexpectedly show that the use of foam material with auxetic characteristics ensures that resonance noise damping not only does not drop with increasing tyre speeds, but actually increases.

1. A tyre comprising an impermeable layer suitable to ensure the sealing under pressure of the air contained in the inner cavity of the carcass and a foam material housed inside said cavity and suitable to provide sound absorption; said tyre being characterized in that said foam material is an auxetic material.

2. A tyre according to claim 1, characterized in that said foam material has a Poisson's ratio of less than zero.

3. A tyre according to claim 1, characterized in that said foam material has a density ranging from 0.01 g/cm3 to 0.15 g/cm³.

4. A tyre according to claim 1, characterized in that said foam material is housed on the surface of the impermeable layer of the inner cavity of said tyre.

5. A tyre according to claim 1, characterized in that said foam material occupies a volume ranging from 0.1% to 100% of the volume of the inner cavity.

6. A tyre according to claim 5, characterized in that said foam material has a thickness ranging from 10 mm to 200 mm and a width ranging from 10% to 100% of the width of the inner cavity.

7. A tyre according to claim 1, characterized in that said foam material occupies a volume ranging from 0.4% to 20% of the volume of the inner cavity.

8. A tyre according to claim 7, characterized in that said foam material has a thickness ranging from 20 mm to 30 mm and a width ranging from 20% to 40% of the width of the inner cavity.

9. A tyre according to claim 1, characterized in that said foam material is housed in the cavity in the form of a toroid, or in the form of a strip with a length equal to that of the impermeable layer, or in the form of single segments assembled so as to cover the entire length of the impermeable layer.
